(19) United States
(12) Patent Application Publication
(10) Pub. No.: US 2017/0264210 A1
(43) Pub. Date: Sep. 14, 2017

(54) CHATTERING-LESS RECTIFICATION CIRCUIT

(71) Applicant: KABUSHIKI KAISHA TOSHIBA, Tokyo (JP)

(72) Inventors: Kazuyasu MINAMI, Yokohama Kanagawa (JP); Hirotoshi AIZAWA, Kawasaki Kanagawa (JP)

(21) Appl. No.: 15/253,772

(22) Filed: Aug. 31, 2016

(30) Foreign Application Priority Data
Mar. 14, 2016 (JP) 2016-049767

(51) Int. Cl. H02M 7/219

(52) U.S. Cl. CPC H02M 7/219; H02M 2007/2195

(57) ABSTRACT

A rectification circuit connected to a coil and a capacitor, includes, on each terminal side of the coil, a high-side transistor connected between a terminal of the coil and the capacitor, first and second low-side transistors connected in parallel between the terminal of the coil and a fixed potential, a comparator that causes the first low-side transistor to be turned on when a voltage of the terminal of the coil decreases to a first value and then turned off when the voltage increases to a second value that is higher than the first value and lower than the fixed potential, and a controller that causes the second low-side transistor to be turned off when the voltage decreases to a third value that is higher than the second value and lower than the fixed potential, and then turned off when the voltage increases to the third value.

### CROSS-REFERENCE TO RELATED APPLICATION

This application is based upon and claims the benefit of priority from Japanese Patent Application No. 2016-049767, filed Mar. 14, 2016, the entire contents of which are incorporated herein by reference.

### FIELD

Embodiments described herein relate generally to a rectification circuit, in particular a rectification circuit that suppresses chattering of terminal voltage.

### BACKGROUND

Recently, in a wireless power supply system, for example, a full bridge circuit using MOS transistors is proposed in order to full-wave rectify an alternating current induced in an antenna coil of a power receiving side. Since the MOS transistors have low on-state resistances in comparison with diodes, the full bridge circuit using the MOS transistors can reduce power loss and increase power reception efficiency in comparison with a full bridge circuit using diodes.

When the MOS transistors are used as switches for synchronous rectification, it is very important to control switching on/off of a low-side MOS transistor. This is because, when the low-side MOS transistor and the high-side MOS transistor connected thereto are turned on simultaneously, an electric charge which is full-wave rectified and stored in a smoothing capacitor may leak into the ground (GND) via the low-side MOS transistor, and the power reception efficiency may greatly deteriorate.

To prevent this problem, a voltage value which is lower than GND is normally set as a threshold value, such that the low-side MOS transistor is not driven beyond GND, and, when a voltage value at a connection point between the high-side MOS transistor and the low-side MOS transistor exceeds the threshold value, the low-side MOS transistor is controlled to be not driven.

However, when the voltage value at the connection point exceeds the threshold value and the low-side MOS transistor switches from an ON state to an OFF state, since the voltage value at the connection point is still below GND, a current is continuously supplied through a body diode of the low-side MOS transistor. As a result, the voltage value at the connection point is reduced as much as a forward voltage (VF) of the body diode. Then, since the voltage value at the connection point becomes lower than the threshold value again, the low-side MOS transistor switches from the OFF state to the ON state.

As described above, since chattering in which the low-side MOS transistor repeats switching on and off occurs from the time when the voltage value at the connection point exceeds the threshold value until the time when the voltage value reaches GND in the related-art full-wave rectification circuit, an unnecessary gate drive loss may occur and the power reception efficiency may deteriorate as a result.

### DESCRIPTION OF THE DRAWINGS

FIG. 1 is a circuit diagram of a full-wave rectification circuit according to a first embodiment.

FIG. 2 illustrates signal waveforms of the full-wave rectification circuit illustrated in FIG. 1.

FIG. 3 illustrates signal waveforms of a full-wave rectification circuit according to a comparative example.

FIG. 4 is a circuit diagram of a full-wave rectification circuit according to a second embodiment.

FIG. 5 is a circuit diagram of another configuration of the full-wave rectification circuit according to the second embodiment.

### DETAILED DESCRIPTION

One embodiment provides a full-wave rectification circuit which can prevent power reception efficiency from decreasing.

In general, according to an embodiment, a rectification circuit that rectifies an alternating current supplied to a coil and charges a capacitor, includes, on each terminal side of the coil, a high-side transistor connected between a terminal of the coil and a terminal of the capacitor, first and second low-side transistors connected in parallel between the terminal of the coil and a fixed potential, a comparator that causes the first low-side transistor to be turned on when a voltage of the terminal of the coil decreases to a first value and then turned off when the voltage increases to a second value that is higher than the first value and lower than the fixed potential, and a controller that causes the second low-side transistor to be turned off when the voltage decreases to a third value that is higher than the second value and lower than the fixed potential, and then turned off when the voltage increases to the third value.

Hereinafter embodiments will be described with reference to the drawings.

### First Embodiment

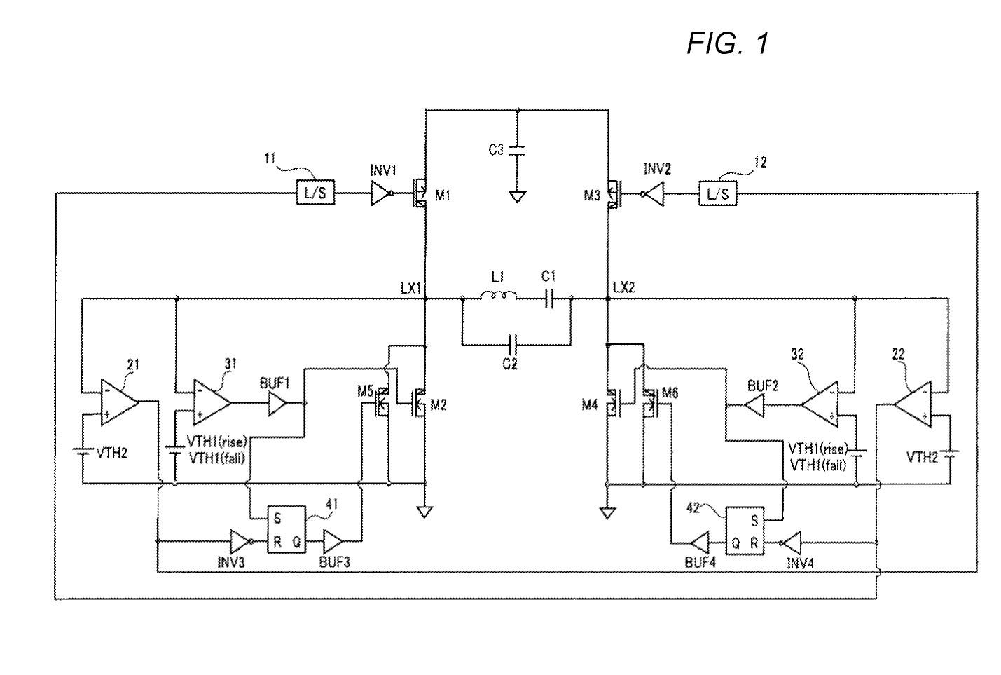

FIG. 1 is a circuit diagram of a full-wave rectification circuit according to a first embodiment. The full-wave rectification circuit illustrated in FIG. 1 reverses a voltage on a negative side of an alternating current voltage which is received at a power reception antenna coil L1, and outputs an absolute value of the input voltage and charges a full-wave rectification smoothing capacitor C3. The full-wave rectification smoothing capacitor C3 reduces a pulse component of a pulsating voltage which is full-wave rectified by a synchronous rectification circuit, and extracts a direct current voltage.

One end of the power reception antenna coil L1 is connected to an input terminal LX1 of one side of the full-wave rectification circuit. In addition, the other end of the power reception antenna coil L1 is connected to an input terminal LX2 of the other side of the full-wave rectification circuit via a series resonance capacitor C1 connected in series. In addition, a parallel load capacitor C2 is connected, in parallel, the power reception antenna coil L1 and the series resonance capacitor C1 which are connected to each other in series. That is, one end of the parallel load capacitor C2 is connected to the input terminal LX1 and the other end is connected to the input terminal LX2.

According to the present embodiment, the full-wave rectification circuit forms a full bridge synchronous rectification circuit which includes four synchronous rectification transistors M1, M2, M3, and M4, four comparators 21, 22, 31, and 32, two buffers BUF1 and BUF2, two inverters INV1 and INV2, and two level shift circuits 11 and 12. The synchronous rectification transistors M1 and M3, which are high-side switches, are formed of P-type MOS transistors, and the synchronous rectification transistors M2 and M4, which are low-side switches, are formed of N-type MOS transistors.

The synchronous rectification transistors M1 and M2, which are the high-side MOS transistor and the low-side MOS transistor, have their respective drains connected to the input terminal LX1. The synchronous rectification transistors M3 and M4, which are the high-side MOS transistor and the low-side MOS transistor, have their respective drains connected to the input terminal LX2. In addition, the synchronous rectification transistors M1 and M3 have their respective sources connected to one end of the full-wave rectification smoothing capacitor C3. The synchronous rectification transistors M2 and M4 have their respective sources connected to GND (ground). Furthermore, the sources of the synchronous rectification transistors M2 and M4 are connected to a fixed potential, and FIG. 1 illustrates a connection that the sources are connected to GND (ground) as an example of the fixed potential.

The comparator 21 has a reverse input to which the input terminal LX1 of the full-wave rectification circuit is connected. In addition, a reference voltage VTH2 is input to a non-reverse input. In addition, the reference voltage VTH2 is set to be slightly lower than GND. In addition, the output of the comparator 21 is input to the gate of the synchronous rectification transistor M3 via the level shift circuit 12 and the inverter INV2. That is, the synchronous rectification transistor M3 is controlled by the comparator 21 to be turned on when the potential of the input terminal LX1 is lower than the VTH2.

The comparator 22 has a reverse input to which the input terminal LX2 of the full-wave rectification circuit is connected. In addition, the reference voltage VTH2 is input to a non-reverse input. In addition, the output of the comparator 22 is input to the gate of the synchronous rectification transistor M1 via the level shift circuit 11 and the inverter INV1. That is, the synchronous rectification transistor M1 is controlled by the comparator 22 to be turned on when the potential of the input terminal LX2 is lower than the VTH2.

The comparator (first comparator) 31 has a reverse input to which the input terminal LX1 of the full-wave rectification circuit is connected. In addition, a reference voltage VTH1 is input to a non-reverse input. Furthermore, the reference voltage VTH1 is set to be lower than the reference voltage VTH2. The reason why the reference voltage VTH2 is set to a value which is higher than the reference voltage VTH1 (a value closer to 0) is as follows. That is, at the time when a current flows into the input terminal LX1, if the synchronous rectification transistor M3 is in an ON state and the synchronous rectification transistor M2 is in an OFF state, a route for allowing the current stored in the full-wave rectification smoothing capacitor C3 to return to the full-wave rectification smoothing capacitor C3 via the synchronous rectification transistor M1, without flowing into GND, is formed, and thus a power loss is reduced.

The output of the comparator 31 is input to the gate of the synchronous rectification transistor M2 via the BUF1. Furthermore, the comparator 31 has hysteresis. For that reason, the synchronous rectification transistor M2 is controlled by the comparator 31 to be turned on when the potential of the input terminal LX1 is reduced to be lower than VTH1 (fall), and to be turned off when the potential of the input terminal LX1 increases to be higher than VTH1 (rise) which is a voltage higher than the VTH1 (fall) by hysteresis.

The comparator (second comparator) 32 has a reverse input to which the input terminal LX2 of the full-wave rectification circuit is connected. In addition, the reference voltage VTH1 is input to a non-reverse input. The output of the comparator 32 is input to the gate of the synchronous rectification transistor M4 via the BUF2. Furthermore, the comparator 32 has the same hysteresis as the comparator 31. For that reason, the synchronous rectification transistor M4 is controlled by the comparator 32 to be turned on when the potential of the input terminal LX2 is reduced to be lower than the VTH1 (fall), and to be turned off when the potential of the input terminal LX2 increases to be higher than the VTH1 (rise) which is a voltage higher than the VTH1 (fall) by hysteresis.

As described above, the comparators 21, 22, 31, and 32 compare the potentials of the input terminals LX1 and LX2, and control timing of on/off of the synchronous rectification transistors M1, M2, M3, and M4, such that a path following the direction of the flow of the alternating current received at the power reception antenna coil L1 has the lowest impedance among paths reaching the full-wave rectification smoothing capacitor C3 from GND via the power reception antenna coil L1.

That is, when the potential of the input terminal LX1 is higher than the potential of the input terminal LX2, an electric charge is stored in the full-wave rectification smoothing capacitor C3 from GND connected to the source of the synchronous rectification transistor M4 via the synchronous rectification transistor M4, the series resonance capacitor C1, the power reception antenna coil L1, and the synchronous rectification transistor M1, by controlling the synchronous rectification transistors M1 and M4 to be turned on and the synchronous rectification transistors M2 and M3 to be turned off. In addition, when the potential of the input terminal LX2 is higher than the potential of the input terminal LX1, an electric charge is stored in the full-wave rectification smoothing capacitor C3 from GND connected to the source of the synchronous rectification transistor M2 via the synchronous rectification transistor M2, the power reception antenna coil L1, the series resonance capacitor C1, and the synchronous rectification transistor M3, by controlling the synchronous rectification transistors M2 and M3 to be turned on and the synchronous rectification transistors M1 and M4 to be turned off.

The full-wave rectification smoothing capacitor C3 has one end to which the sources of the synchronous rectification transistors M1 and M3 are connected, and the other end to which GND is connected. The alternating current which is induced in the power reception antenna coil L1 is full-wave rectified by the full-wave rectification circuit, and is stored in the full-wave rectification smoothing capacitor C3.

In addition, the full-wave rectification circuit according to the present embodiment has synchronous rectification transistors M5 and M6 which are sub low-side switches, two SR latches 41 and 42, two buffers BUF3 and BUFS4, and two inverters INV3 and INV4. The synchronous rectification transistors M5 and M6 are formed of N-type MOS transistors which have a greater on-state resistance (a smaller size) than that of the synchronous rectification transistors M2 and M4, which are the main low-side switches.

The output of the comparator 31 is input to a set input terminal of the SR latch 41 via the buffer BUF1. The output of the comparator 21 is input to a reset input terminal of the SR latch 41 via the inverter INV3. Q output of the SR latch 41 is input to the gate of the synchronous rectification transistor M5 via the buffer BUF3. That is, the synchronous rectification transistor M5, which is a first sub low-side MOS transistor, is connected to the synchronous rectification transistor M2, which is the main low-side switch in parallel, and is controlled by the SR latch 41 which is a first controller to switch on/off at different timing from the synchronous rectification transistor M2.

The output of the comparator 32 is input to a set input terminal of the SR latch 42 via the buffer BUF2. The output of the comparator 22 is input to a reset input terminal of the SR latch 42 via the inverter INV4. Q output of the SR latch 42 is input to the gate of the synchronous rectification transistor M6 via the buffer BUF4. That is, the synchronous rectification transistor M6, which is a second sub low-side MOS transistor, is connected to the synchronous rectification transistor M4, which is the main low-side switch in parallel, and is controlled by the SR latch 42 which is a second controller to switch on/off state at different timing from the synchronous rectification transistor M4.

Next, synchronous rectification operations of the synchronous rectification transistors M2 and M5 when the direction of a current flowing into the LX1 terminal changes in this order of a positive (inflow), a negative (outflow), and a positive (inflow) during the full-wave rectification will be described. A current flowing into the LX2 terminal and synchronous rectification operations of the synchronous rectification transistors M4 and M6 have an inverse current direction, and are the same as the current flowing into the LX1 terminal and the synchronous rectification operations of the synchronous rectification transistors M2 and M5, and thus a detailed description thereof is omitted.

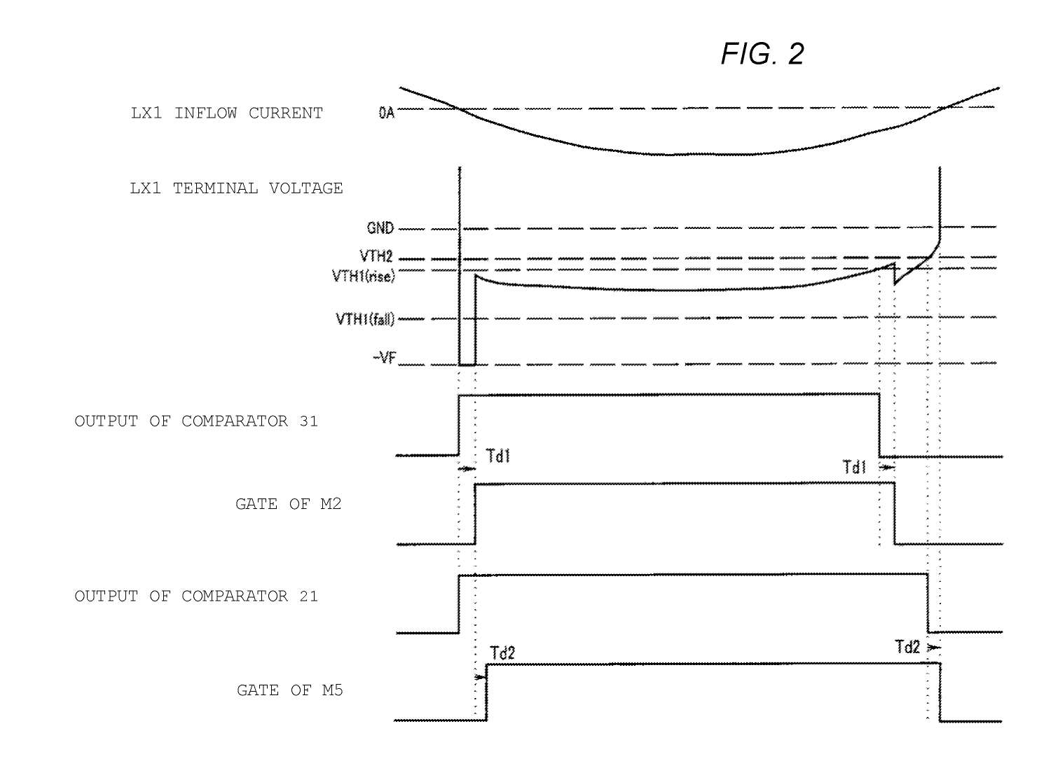

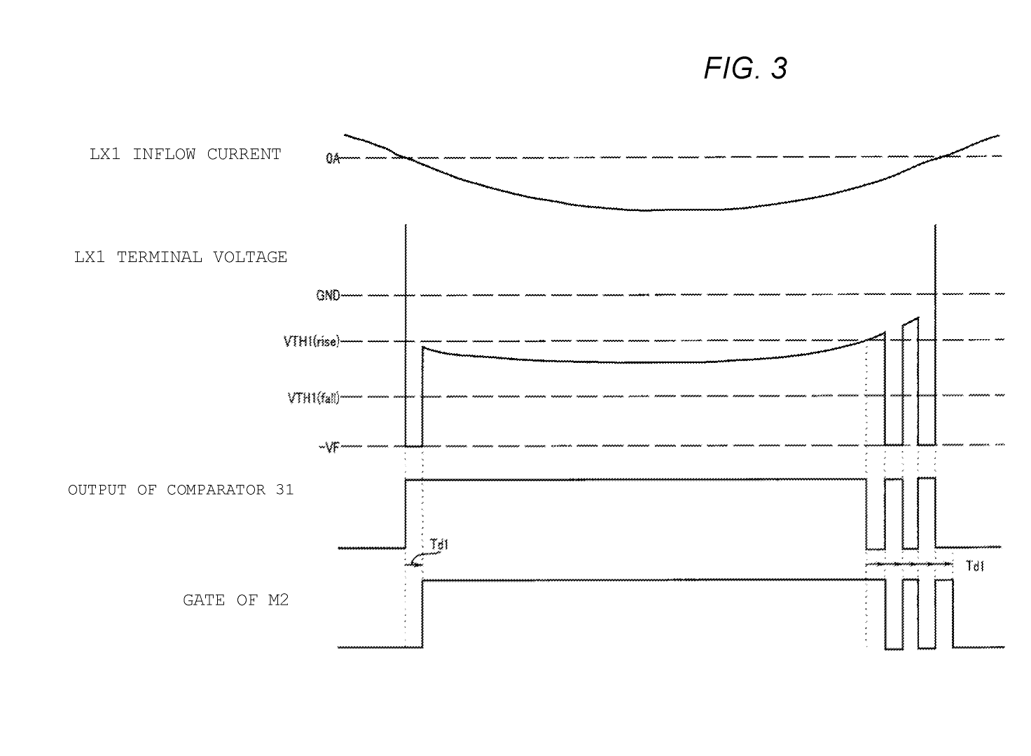

FIG. 2 illustrates signal wave forms at respective points of the full-wave rectification circuit illustrated in FIG. 2. FIG. 2 illustrate wave forms of an inflow current of the input terminal LX1, a voltage of the input terminal LX1, an output signal of the comparator 31, an input signal of the gate of the synchronous rectification transistor M2, an output signal of the comparator 21, and an input signal of the gate of the synchronous rectification transistor M5. FIG. 3 illustrates signal wave forms in a full-wave rectification circuit according to a comparative example. The full-wave rectification circuit of the comparative example does not include, in comparison to the full-wave rectification circuit illustrated in FIG. 1, the synchronous rectification transistors M5 and M6 which are the sub low-side switches, the two SR latches 41 and 42 for controlling switch on/off of the gates of the synchronous rectification transistors M5 and M6, the two buffers BUF3 and BUF4, and the two inverters INV3 and INV4. FIG. 3 illustrates wave forms of the inflow current of the input terminal LX1, the voltage of the input terminal LX1, the output signal of the comparator 31, and the input signal of the gate of the synchronous rectification transistor M2.

As illustrated in FIG. 2, the voltage of the input terminal LX1 is GND and higher than the reference voltage VTH2 right after the current flowing into the input terminal LX1 is reduced, and is below 0A and starts leaking. Accordingly, since the gate signal of the synchronous rectification transistor M1 is “H” (=OFF state) under the control of the comparator 22, the voltage of the input terminal LX1 is reduced.

When the voltage of the input terminal LX1 becomes lower than the reference voltage VTH2, the output value of the comparator 21 switches from “L” to “H”. At this time, since the voltage of the input terminal LX1 is higher than the reference voltage VTH1 (fall), the output value of the comparators 31 remains as “L.” Since the set input to the SR latch 41 is “L” and the reset input changes from “H” to “L,” the Q output retains “L.” That is, the gate maintains the OFF state with the synchronous rectification transistors M2 and M5.

When the voltage of the input terminal LX1 is further reduced and is below the reference voltage VTH1 (fall), the output value of the comparator 31 switches from “L” to “H.” Since the gate signal of the synchronous rectification transistor M2 is “L” and in the OFF state during the time (delay time Td1) until the output signal of the comparator 31 reaches the gate of the synchronous rectification transistor M2, the outflow current of the input terminal LX1 is supplied to the body diode of the synchronous rectification transistor M2. For that reason, when the forward voltage of the body diode of the synchronous rectification transistor M2 is VF, the voltage of the input terminal LX1 is reduced to −VF.

Furthermore, although a current is supplied from the body diode of the synchronous rectification transistor M5 to the input terminal LX1, since the size of the synchronous rectification transistor M5 is very small in relation to the synchronous rectification transistor M2, the influence of the body diode of Td1 can be ignored.

After the delay time Td1 passes, the gate signal of the synchronous rectification transistor M2 switches from “L” to “H” and goes into an ON state. Accordingly, the voltage of the input terminal LX1 equals ILX1×Ron2 (Herein, ILX1 indicates the current flowing into the input terminal LX1, and Ron2 indicates the on-state resistance of the synchronous rectification transistor M2.). The output signal “H” of the comparator 31 is set-input to the SR latch 41 at the same time of reaching the gate of the synchronous rectification transistor M2. Since the reset input of the SR latch 41 is “L,” the Q output changes from “L” to “H.” When a propagation delay time from the Q output from the SR latch 41 to the synchronous rectification transistor M5 is Td2, the gate signal of the synchronous rectification transistor M5 switches from “L” to “H” and the synchronous rectification transistor M5 goes into the ON state after the synchronous rectification transistor M2 switches to the ON state and then the delay time Td2 passes. Furthermore, when the synchronous rectification transistor M5 goes into the ON state, the voltage of the input terminal LX1 is changed by the on-state resistance Ron5 of the synchronous rectification transistor M5, but, since the size of the synchronous rectification transistor M5 is even smaller than the size of the synchronous rectification transistor M2, the influence on the voltage of the input terminal LX1 can be ignored.

Since the Ron5 is a great value in comparison with the Ron2, a conduction loss increases when the synchronous rectification transistor M5 is turned on before the synchronous rectification transistor M2 is turned on. In this respect, in the full-wave rectification circuit according to the present embodiment, the synchronous rectification transistor M5 can be prevented from switching to the ON state before the synchronous rectification transistor M2 switches to the ON state, by inputting the output signal of the comparator 31 to the synchronous rectification transistor M5 via the SR latch 41.

When the current flowing out of the input terminal LX1 is reduced after the synchronous rectification transistors M2 and M5 switch to the ON state, the voltage of the input terminal LX1 increases and becomes closer to GND. When the current flowing out of the input terminal LX1 becomes close to 0A and the voltage of the input terminal LX1 exceeds the reference voltage VTH1 (rise), the output value of the comparator 31 switches from “H” to “L.” After the delay time Td1 passes, the gate signal of the synchronous rectification transistor M2 switches from “H” to “L” and goes into the OFF state.

The change in the voltage of the input terminal LX1 described above shows the same behavior in the full-wave rectification circuit of the present embodiment illustrated in FIG. 2 and the full-wave rectification circuit of the comparative example illustrated in FIG. 3, but the behavior thereafter is different. In the case of the full-wave rectification circuit of the comparative example as illustrated in FIG. 3, at the time when the synchronous rectification transistor M2 switches to the OFF state, the voltage of the input terminal LX1 is still below GND, and thus the current flowing out of the input terminal LX1 is supplied to the body diode of the synchronous rectification transistor M2. As a result, the voltage of the input terminal LX1 is reduced to −VF.

When the voltage of the input terminal LX1 becomes lower than the reference voltage VTH1 (fall), the output value of the comparator 31 switches from “L” to “H.” Since the gate signal of the synchronous rectification transistor M2 switches from “L” to “H” after the delay time Td1 passes, the synchronous rectification transistor M2 goes into the ON state again. At this time, since the current flowing out of the input terminal LX1 is further reduced, the voltage of the input terminal LX1 increases and becomes closer to GND. That is, since the voltage of the input terminal LX1 is above the reference voltage VTH1 (rise), the output value of the comparator 31 switches from “H” to “L.” In addition, after the delay time Td1 passes, the gate signal of the synchronous rectification transistor M2 switches from “H” to “L” and goes into the OFF state.

When the voltage of the input terminal LX1 is still below GND, the outflow current of the input terminal LX1 is supplied to the body diode of the synchronous rectification transistor M2 and the voltage of the input terminal LX1 is reduced to −VF. In addition, the following operations are repeatedly carried out in this order: 1) the output value of the comparator 31 switches from “L” to “H”; 2) the synchronous rectification transistor M2 is turned on after the delay time Td1 passes; 3) the output value of the comparator 31 switches from “H” to “L”; 4) the synchronous rectification transistor M2 is turned off after the delay time Td1 passes. A series of these operations is repeated at the time when the synchronous rectification transistor M2 switches to the OFF state until the voltage of the input terminal LX1 becomes higher than GND.

When the synchronous rectification transistor M2 switches to the OFF state, if the voltage of the input terminal LX1 is above GND, the voltage of the input terminal LX1 further increases since the current starts to flow into the input terminal LX1. That is, the output value of the comparator 31 is stabilized as “L” and the synchronous rectification transistor M2 retains the OFF state during the time until the current flowing into the input terminal LX1 is reduced and below 0A.

As described, when the current flowing out of the input terminal LX1 is reduced and the voltage of the input terminal LX1 becomes higher than the reference voltage VTH1 (rise) in the synchronous rectification circuit of the comparative example, chattering in which the synchronous rectification transistor M2 repeats switching on and off many times occurs during the time until the voltage of the input terminal LX1 becomes higher than GND.

In contrast, according to the full-wave rectification circuit of the present embodiment, when the synchronous rectification transistor M2 switches to the OFF state as illustrated in FIG. 2, the output signal “L” of the comparator 31 is input to the SR latch 41. As a result, since the set input of the SR latch 41 changes form “H” to “L” although the reset input is “L,” the Q output remains to be “H.” Accordingly, since the synchronous rectification transistor M2 goes into the OFF state and the synchronous rectification transistor M5 goes into the ON state, the voltage of the input terminal LX1 equals to ILX×Ron5.

Herein, the values of Ron5 and VTH1 (fall) are adjusted such that ILX1×Ron5 becomes a voltage higher than the VTH1 (fall). In other words, the values of Ron2 and Ron5 are adjusted such that the VTH1 (fall) and the VTH1 (rise) satisfy the following equation (1):

|VTH1(fall)|/|VTH1(rise)|>Ron5/Ron2 Equation 1

For example, in the case of VTH1 (rise)×10=VTH1 (fall), Ron2 and Ron5 are adjusted to satisfy Ron2×10>Ron5. Thus, even when the synchronous rectification transistor M2 switches from the ON state to the OFF state, the output value of the comparator 31 remains to be “L” to prevent the voltage of the input terminal LX1 from being below the VTH1 (fall). Accordingly, the synchronous rectification transistor M2 can be prevented from being tuned on again.

When the current flowing out of the input terminal LX1 is further reduced and the voltage of the input terminal LX1 becomes higher than the reference voltage VTH2, the output value of the comparator 21 switches from “H” to “L.” That is, since the set input to the SR latch 41 is “L” and the reset input changes from “L” to “H,” the Q output switches from “H” to “L.” Accordingly, since the gate signal of the synchronous rectification transistor M5 switches from “H” to “L” after the delay time Td2 passes, the gate of the synchronous rectification transistor M5 goes into the OFF state.

Herein, since the reference voltage VTH2 is set to a value close to GND, the voltage of the input terminal LX1 at the time when the synchronous rectification transistor M5 switches to the OFF state is above GND. That is, since the current is flowing into the input terminal LX1, the voltage of the input terminal LX1 further increases. Since the output values of the comparators 21 and 31 are stabilized as “L” during the time until the current flowing into the input terminal LX1 is reduced and becomes lower than 0A, the synchronous rectification transistors M2 and M5 remains to be in the OFF state.

According to the present embodiment, even when the current flowing out of the input terminal LX1 is reduced and the voltage of the input terminal LX1 becomes higher than the reference voltage VTH1 (rise), and thus the synchronous rectification transistor M2 switches from the ON state to the OFF state, the synchronous rectification transistor M5 provided in parallel with the synchronous rectification transistor M2 remains to be in the ON state. At this time, since the voltage (=ILX×Ron5) of the input terminal LX1 is adjusted to be higher than the VTH1 (fall), the output value of the comparator 31 can continuously remain to be “L,” and the synchronous rectification transistor M2 can be prevented from being turned on again. Since the chattering in which the synchronous rectification transistor M2 repeats switching on and off many times can be prevented, an unnecessary gate drive loss can be suppressed and the deterioration of the power reception efficiency can be prevented.

### Second Embodiment

The full-wave rectification circuit of the first embodiment controls the switch on/off of the synchronous rectification transistors M1 and M3, which are the high-side switches, and the switch on/off of the synchronous rectification transistors M5 and M6, which are the sub low-side switches, simultaneously, based on the output values of the comparators 21 and 22. A full-wave rectification circuit of a second embodiment differs in that an independent circuit controls the switch on/off of the synchronous rectification transistors M1 and M3 and the switch on/off of the synchronous rectification transistors M5 and M6.

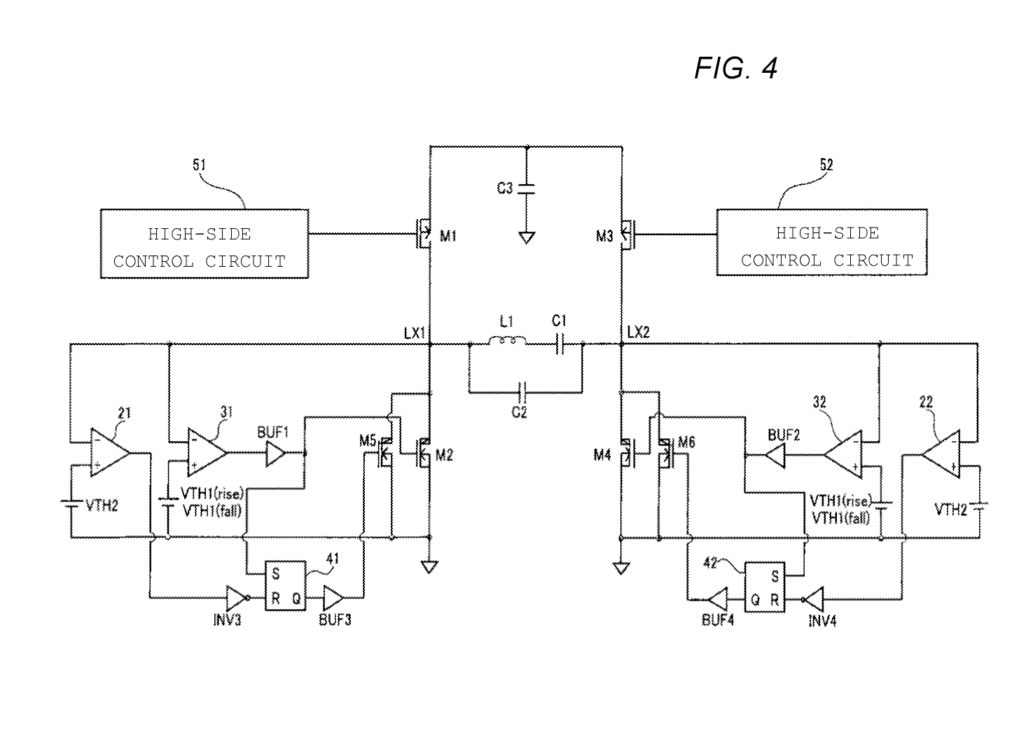

FIG. 4 is a circuit diagram of the full-wave rectification circuit according to the second embodiment. As illustrated in FIG. 4, the value output from the comparator 21 is input to the reset input terminal of the SR latch 41 via the inverter INV3. To the gate of the synchronous rectification transistor M3, a control signal from a high-side control circuit 52, rather than the value output from the comparator 21, is input. The high-side control circuit 52 outputs a control signal to control the synchronous rectification transistor M3 to switch to the ON/OFF state when the potential of the input terminal LX1 is lower/higher than a predetermined reference potential VTH3 (not illustrated; a value close to 0V and not exceeding 0V), respectively.

The value output from the comparator 22 is input to the reset input terminal of the SR latch 42 via the inverter INV4. To the gate of the synchronous rectification transistor M1, a control signal from a high-side control circuit 51, rather than the value output from the comparator 22, is input. The high-side control circuit 51 outputs a control signal to control the synchronous rectification transistor M1 to switch to the ON/OFF state when the potential of the input terminal LX2 is lower/higher than the predetermined reference potential VTH3 (a value close to 0V and not exceeding 0V), respectively.

According to the present embodiment, the switch on/off of the synchronous rectification transistors M5 and M6, which are the sub low-side switches, is controlled by the comparators 21 and 22, respectively, and the switch on/off of the synchronous rectification transistors M1 and M3, which are the high-side switches, are controlled by the high-side control circuits 51 and 52, respectively. Thus, the reference potential VTH2 for switching on/off the synchronous rectification transistors M5 and M6, and the reference potential VTH3 for switching on/off the synchronous rectification transistors M1 and M3 may be set to different values.

In addition, the timing of switching on/off the synchronous rectification transistors M5 and M6 and the timing of switching on/off the synchronous rectification transistors M1 and M3 can be adjusted by separate circuits. Accordingly, it is easy to control switching on/off of the synchronous rectification transistors M5 and M6, and the chattering can be more reliably prevented.

Furthermore, the switch on/off of the synchronous rectification transistors M5 and M6 is controlled such that the input terminal LX1 becomes above GND right after the synchronous rectification transistors M5 and M6 switch from the ON state to the OFF state. As a result, as described above, instead of controlling the timing by comparing the reference potential VTH2 which is close to GND and does not exceed GND, and the potential of the input terminal LX1, the timing of switching on/off the synchronous rectification transistors M5 and M6 may be controlled based on times elapsed since the synchronous rectification transistors M2 and M4 switched from the ON state to the OFF state.

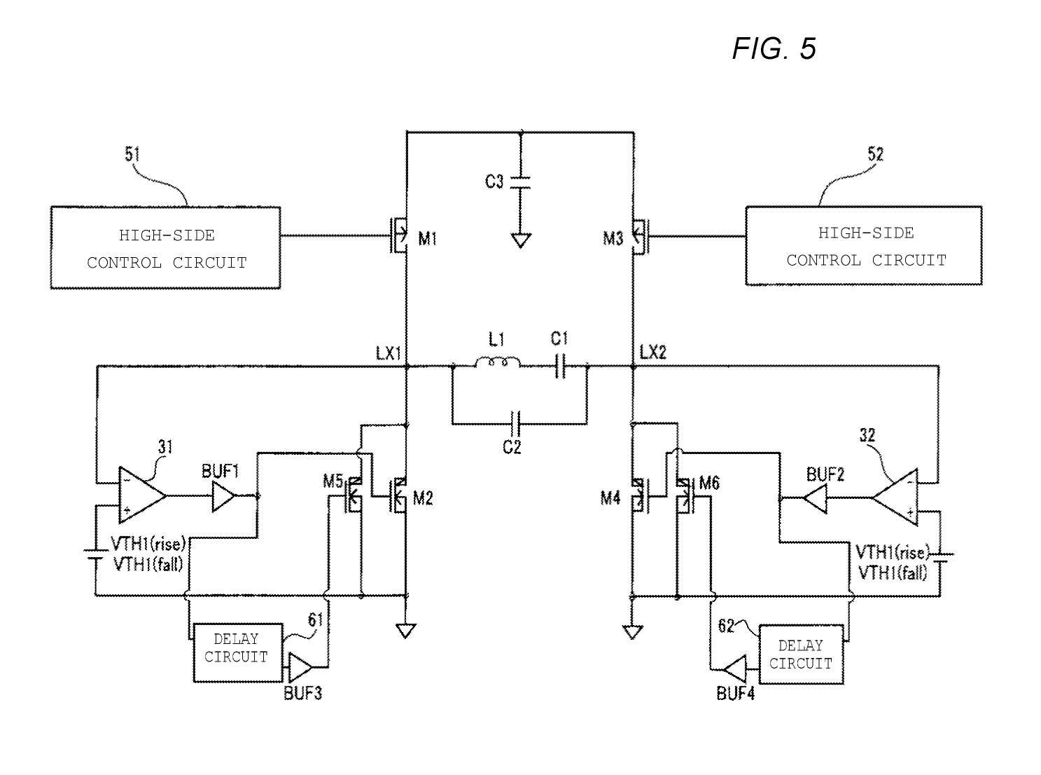

FIG. 5 is a circuit diagram illustrating another configuration of the full-wave rectification circuit according to the second embodiment. As illustrated in FIG. 5, a value output from the comparator 31 is input to the gate of the synchronous rectification transistor M5 via the buffer BUF1, a delay circuit 61, and the buffer BUF3. A value output from the comparator 32 is input to the gate of the synchronous rectification transistor M6 via the buffer BUF2, a delay circuit 62, and the buffer BUF4.

That is, according to the configuration illustrated in FIG. 5, a delay time since the synchronous rectification transistors M2 and M4 switched from the ON state to the OFF state until the synchronous rectification transistors M5 and M6 switch on/off may be controlled by adjusting the time to output signals from the delay circuits 61 and 62. Accordingly, since the comparators 21 and 22 or the SR latches 41 and 42 are not required, the size of the circuit can be reduced and the apparatus can be miniaturized.

The term “unit” used in the specification is a concept corresponding to each function of the above embodiment, and does not necessarily correspond to specific hardware or software/routine. Accordingly, in the specification, a virtual circuit block (unit) having each function of the above embodiment has been assumed and described.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rectification circuit that rectifies an alternating current supplied to a coil and charges a capacitor, comprising, on each terminal side of the coil:
a high-side transistor connected between a terminal of the coil and a terminal of the capacitor;
first and second low-side transistors connected in parallel between the terminal of the coil and a fixed potential;
a comparator that causes the first low-side transistor to be turned on when a voltage of the terminal of the coil decreases to a first value and then turned off when the voltage increases to a second value that is higher than the first value and lower than the fixed potential; and
a controller that causes the second low-side transistor to be turned on when the voltage decreases to a third value that is higher than the second value and lower than the fixed potential, and then turned off when the voltage increases to the third value.

2. The rectification circuit according to claim 1, wherein
on said each terminal side of the coil, an on-resistance of the first low-side transistors is lower than an on-resistance of the second low-side transistor.

3. The rectification circuit according to claim 1, wherein
on said each terminal side of the coil, an on-resistance of the second low-side transistor divided by an on-resistance of the first low-side transistor is smaller than the difference between the fixed potential and the first value divided by the difference between the fixed potential and the second value.

4. The rectification circuit according to claim 1, further comprising, on said each terminal side of the coil,
a second comparator that causes the second low-side transistor to be turned off when the voltage decreases to the third value, and then turned off when the voltage increases to the third value.

5. The rectification circuit according to claim 1, wherein
on said each terminal side of the coil, the controller causes the high-side transistor on an opposite terminal side of the coil to be turned on when the voltage decreases to the third value and then turned off when the voltage increases to the third value.

6. The rectification circuit according to claim 1, further comprising, on said each terminal side of the coil:
a second controller that causes the high-side transistor to be turned on when a voltage of an opposite terminal of the coil decreases to a fourth value that is lower than the fixed potential and then turned off when said voltage increases to the fourth value.

7. The rectification circuit according to claim 1, wherein
the fixed potential is ground potential.

8. A rectification circuit that rectifies an alternating current supplied to a coil and charges a capacitor, comprising, on each terminal side of the coil:
a high-side transistor connected between a terminal of the coil and a terminal of the capacitor;
first and second low-side transistors connected in parallel between the terminal of the coil and a fixed potential; and
a comparator that causes the first low-side transistor to be turned on when a voltage of the terminal of the coil decreases to a first value and then turned off when the voltage increases to a second value that is higher than the first value and lower than the fixed potential, wherein
the second low-side transistor is turned off after the voltage increases to the second value and before the voltage reaches the fixed potential.

9. The rectification circuit according to claim 8, comprising, on said each terminal side of the coil:
a delay circuit that causes the second low-side transistor to be turned off after the voltage increases to the second value and before the voltage reaches the fixed potential.

10. The rectification circuit according to claim 9, wherein
the delay circuit also causes the second low-side transistor to be turned on after the voltage decreases the first value.

11. The rectification circuit according to claim 8, wherein
on said each terminal side of the coil, an on-resistance of the first low-side transistors is lower than an on-resistance of the second low-side transistor.

12. The rectification circuit according to claim 8, wherein
on said each terminal side of the coil, an on-resistance of the second low-side transistor divided by an on-resistance of the first low-side transistor is smaller than the difference between the fixed potential and the first value divided by the difference between the fixed potential and the second value.

13. The rectification circuit according to claim 8, further comprising, on said each terminal side of the coil:
a controller that causes the high-side transistor to be turned on when a voltage of an opposite terminal of the coil decreases to a third value that is lower than the fixed potential and then turned off when the voltage increases to the third value.

14. The rectification circuit according to claim 8, wherein
the fixed potential is ground potential.

15. A method for controlling a rectification circuit that rectifies an alternating current supplied to a coil and charges a capacitor, the rectification circuit including, on each terminal side of the coil, a high-side transistor connected between a terminal of the coil and a terminal of the capacitor, and first and second low-side transistors connected in parallel between the terminal of the coil and a fixed potential, the method comprising, on said each terminal side:
turning on the first low-side transistor when a voltage of the terminal of the coil decreases to a first value, and then turning off the first low-side transistor when the voltage increases to a second value that is higher than the first value and lower than the fixed potential; and
turning on the second low-side transistor when the voltage decreases to a third value that is higher than the second value and lower than the fixed potential, and then turning off the second low-side transistor when the voltage increases to the third value.

16. The method according to claim 15, wherein
on said each terminal side of the coil, an on-resistance of the first low-side transistors is lower than an on-resistance of the second low-side transistor.

17. The method according to claim 15, wherein
on said each terminal side of the coil, an on-resistance of the second low-side transistor divided by an on-resistance of the first low-side transistor is smaller than the difference between the fixed potential and the first value divided by the difference between the fixed potential and the second value.

18. The method according to claim 15, further comprising, on said each terminal side:
turning on the high-side transistor when a voltage of an opposite terminal of the coil decreases to a fourth value that is lower than the fixed potential, and then turning off when the voltage increases to the fourth value.

19. The method according to claim 18, wherein
the third value is different from the fourth value.

20. The method according to claim 15, wherein
the fixed potential is ground potential.
